(19) United States
(12) Patent Application Publication
(10) Pub. No.: US 2012/0085844 A1
(43) Pub. Date: Apr. 12, 2012

(54) ELECTROSTATIC SPRAYING DEVICE

(75) Inventors: Mamoru Okumoto, Osaka (JP); Kouei Obata, Osaka (JP); Masashi Kamada, Osaka (JP); Yume Inokuchi, Osaka (JP)

(73) Assignee: DAIKIN INDUSTRIES, LTD., Osaka-shi, Osaka (JP)

(21) Appl. No.: 13/376,080

(22) PCT Filed: Jun. 2, 2010
(86) PCT No.: PCT/JP2010/003687

§ 371 Date: Dec. 2, 2011

(30) Foreign Application Priority Data
Jun. 3, 2009 (JP) 2009-133804

(51) Int. Cl. B05B 5/00

(52) U.S. Cl. 239/708

(57) ABSTRACT

An electrostatic spraying device (1) includes a tank (11) in which a liquid is stored, a gas supply path (6a) which communicates with the tank (11), a pump (2) which applies pressure to the liquid in the tank (11) by supplying air to the tank (11) via the gas supply path (6a), and a control section (4) which controls a supply operation of the pump (2) to adjust a pressure in the tank (11).

### TECHNICAL FIELD

The present invention relates to electrostatic spraying devices which spray a charged liquid.

### BACKGROUND ART

Electrostatic spraying devices in which a liquid stored in a tank is charged by applying a voltage, and the liquid is sprayed out of the tank through a nozzle have been known. Such electrostatic spraying devices are used, for example, for atomizing a cosmetic liquid which contains a moisturizing ingredient and an antioxidant ingredient (such as a liquid containing a hyaluronic acid) to a face, etc., for beauty care.

Such electrostatic spraying devices include an electrostatic spraying device disclosed, for example, in Patent Document 1 which includes a flexible tank having a nozzle for discharging a liquid stored in the tank to the outside, a generally plate-like pressing member for compressing the flexible tank by placing the tank between the pressing member and a generally plate-like base member, a constant-load spring for pressing the pressing member to compress the tank, and a voltage applying section for applying a voltage to the liquid from the end of the nozzle.

In this structure, when the pressing member is pressed by the restoring force of the constant-load spring, the pressing member compresses the tank and moves the liquid in the tank to the nozzle. The liquid which is moved to the nozzle is charged by the voltage applying section provided at the end of the nozzle. Thus, single polarity charges gather near the air-liquid interface of the nozzle end. As a result, the single polarity charges of the liquid repel one another by electrostatic force, and the liquid is atomized from the nozzle as droplets.

Another example of the structure in which a liquid in a tank is supplied to a nozzle is disclosed, for example, in Patent Document 2 in which a liquid pump is used. In the structure of Patent Document 2, the tank in which a liquid is stored is connected to a nozzle through a communicating path. The liquid in the tank is supplied to the nozzle by a liquid pump provided to the communicating path.

### Citation List

### Patent Document

Patent Document 1: Japanese Patent Publication No. 2009-022891

Patent Document 2: Japanese Patent Publication No. 2008-025519

### SUMMARY OF THE INVENTION

### Technical Problem

However, in the electrostatic spraying device using a constant-load spring to press the pressing member, the restoring force of the constant-load spring may differ among different constant-load springs, or the restoring force of the constant-load spring may decrease with repeated use of the constant-load spring. As a result, the amount of liquid to be supplied to the nozzle may vary significantly.

Further, in the electrostatic spraying device using a liquid pump to spray a liquid from the nozzle, a control circuit controls the driving of the liquid pump. Thus, it is necessary to provide insulation so that the electrical components forming the control circuit will not be electrically influenced, such as generating noise or being damaged. This makes the structure of the electrostatic spraying device complicated, and increases the cost.

The present invention was made in view of the above problems, and it is an objective of the invention to provide an electrostatic spraying device configured to supply a charged liquid to a nozzle from which the charged liquid is sprayed, in which an amount of liquid to be sprayed is stabilized, and an electrical component such as a control circuit of a device for supplying the liquid to the nozzle is electrically insulated from the charged liquid in an easy and reliable manner.

### Solution to the Problem

To achieve the above objective, an electrostatic spraying device (1) according to the present invention is configured to supply gas into a tank (11) by a gas supply system (2) and apply pressure to a liquid in the tank (11), thereby supplying the liquid to the end of a nozzle (12).

Specifically, the first aspect of the present invention includes: a tank (11) in which a liquid is stored; a nozzle (12) provided in the tank (11); a voltage applying section (13) for charging the liquid in the tank (11) so that the liquid is sprayed from an end portion of the nozzle (12) to the outside; a gas supply path (6a) which communicates with the tank (11); a gas supply system (2) connected to the gas supply path (6a), for supplying a gas to the tank (11) via the gas supply path (6a); and a control section (4, 16) for controlling a supply operation of the gas supply system (2) to adjust a pressure in the tank (11).

In the first aspect of the present invention, gas is supplied to the tank (11) by the gas supply system (2) to apply pressure to the liquid in the tank (11), and the liquid charged by the voltage applying section (13) is supplied to the nozzle (12). With this structure, the liquid is sprayed from the end of the nozzle (12). Since the liquid can be sprayed in a stable manner by using gas to apply pressure to the liquid in the tank (11 as described above, it is possible to eliminate, unlike the conventional case, variations in the amount of liquid sprayed which may be caused due to individual differences of the constant-load springs.

Further, since the liquid in the tank (11) is pressurized by the gas supplied from the gas supply system (2), gas is always present between the gas supply system (2) and the liquid in the tank (11). Therefore, the gas supply system (2) can be prevented from being in direct contact with the charged liquid. As a result, the control section (4, 16) for controlling a supply operation of the gas supply system (2) can be prevented from being electrically influenced, such as generating noise or being damaged, from the charged liquid via the gas supply system (2).

The second aspect of the present invention is that the gas supply system is a pump (2) which pumps the gas to the tank (11), and that the control section (4, 16) is configured to control driving of the pump (2), in the first aspect of the present invention.

In the second aspect of the present invention, the liquid in the tank (11) is pressurized by the gas supplied from the pump (2), and the driving of the pump (2) is controlled by the control section (4, 16) to control the spraying of the liquid in the tank (11).

The third aspect of the present invention is that the tank (11) is made of an insulating resin material in the first or second aspect of the present invention.

In the third aspect of the present invention, the tank (11) is made of an insulating material. Thus, the voltage applying section (13) and the gas supply system (2) are electrically insulated from each other.

The fourth aspect of the present invention is that the control section (4) stops the pump (2) when the pressure in the tank (11) reaches an upper limit during an operation of the pump (2), and activates the pump (2) when the pressure in the tank (11) reaches a lower limit during a halt of the pump (2), in the second aspect of the present invention.

In the fourth aspect of the present invention, the pressure in the tank (11) can be set to a value between the upper limit and the lower limit which are determined beforehand. Thus, it is possible to maintain the amount of liquid to be sprayed from the nozzle (12) in a predetermined range. Moreover, in the above structure, the liquid in the tank (11) can be pressurized without activation of the pump (2) from when the pressure in the tank (11) reaches the upper limit until when the pressure in the tank (11) reaches the lower limit. Thus, the operational cost of the pump (2) during this period can be reduced.

The fifth aspect of the present invention is that the control section (4) is configured to be able to change at least one of the upper limit or the lower limit, in the fourth aspect of the present invention.

In the fifth aspect of the present invention, a range of pressures applied to the liquid in the tank (11) is changed by changing the upper limit or the lower limit of the pressure on the liquid in the tank (11). In such a case, the liquid is sprayed from the nozzle (12) in an amount corresponding to the changed range of pressures. As a result, in this structure, the amount of liquid to be sprayed from the nozzle (12) can be controlled.

The sixth aspect of the present invention is that a pressure sensor (3) for measuring the pressure in the tank (11) is provided to the gas supply path (6a), in the fourth or fifth aspect of the present invention.

In the sixth aspect of the present invention, the gas supply path (6a) is a path which leads a gas from the pump (2) to the tank (11). Thus, the provision of the pressure sensor (3) to the gas supply path (6a) allows the pressure sensor (3) to be always surrounded by gas. This means that the pressure sensor (3) is electrically insulated from the charged liquid in the tank (11) by the gas. Therefore, the pressure sensor (3) can be prevented from being in direct contact with the charged liquid in the tank (11), and being electrically influenced, such as generating noise or being damaged.

The seventh aspect of the present invention is that the control section (16) controls the driving of the pump (2) such that the pump (2) performs an intermittent operation in which an operation and a halt of the pump (2) are repeated in a predetermined cycle, in the second aspect of the present invention.

In the seventh aspect of the present invention, the pump (2) does not have to be always on, and the liquid can be sprayed from the end of the nozzle (12) as long as the pressure in the tank (11) is such a pressure which allows the liquid to be supplied to the nozzle (12). Thus, the intermittent operation of the pump (2) as described above can improve the efficiency of the operation of the pump (2). Further, the operational cost of the pump (2) can be reduced.

The eighth aspect of the present invention is that the control section (16) is configured to be able to change at least one of an operation time or a halt time of the pump (2) in the seventh aspect of the present invention.

In the eighth aspect of the present invention, it is possible to change a range of pressures on the liquid in the tank (11). That is, if the operation time of the pump (2) is increased, the upper limit of the pressure on the liquid in the tank (11) is increased. If the operation time is reduced, the upper limit of the pressure on the liquid in the tank (11) is lowered. Further, if the halt time of the pump (2) is increased, the lower limit of the pressure on the liquid in the tank (2) is lowered. If the halt time is reduced, the lower limit of the pressure on the liquid in the tank (2) is increased.

### ADVANTAGES OF THE INVENTION

In the first aspect of the present invention, the gas supply system (2) for supplying gas to the tank (11) is provided to apply pressure to the liquid in the tank (11) by the gas. Thus, the liquid in the tank (11) can be sprayed from the end of the nozzle (12) in a stable manner.

Further, since the gas is present between the gas supply system (2) and the charged liquid in the tank (11), it is possible to prevent the control section (4, 16) which controls a supply operation of the gas supply system (2), from being electrically insulated from the charged liquid.

In the second aspect of the present invention, the gas supply system is a pump (2) of which the driving is controlled by the control section (4, 16). Thus, it is possible to provide a mechanism in which the liquid in the tank (11) is pressurized by the gas, and possible to control the amount of liquid to be sprayed from the nozzle (12).

In the third aspect of the present invention, the tank (11) is made of an insulating material. Thus, the voltage applying section (13) and the gas supply system (2) can be electrically insulated from each other. As a result, it is possible to prevent the control section (4, 16) from being electrically influenced, such as generating noise, from the voltage applying section (13).

In the fourth aspect of the present invention, the control section (4) is configured to control the operation and halt of the pump (2) according to the pressure in the tank (11). Thus, the pressure in the tank (11) can be maintained in a predetermined range, and the amount of liquid to be sprayed from the nozzle (12) can be adjusted. Moreover, the operational cost of the pump (2) can be reduced more than in the case where the pump (2) is always on.

In the fifth aspect of the present invention, the control section (4) is configured to be able to change the upper limit and/or the lower limit of the pressure in the tank (11). Thus, it is possible to change the pressure in the tank (11), and thereby possible to adjust the amount of liquid to be sprayed from the nozzle (12).

In the sixth aspect of the present invention, the pressure sensor (3) is located on the gas supply path (6a) to which pump (2) is provided, and is electrically insulated from the charged liquid in the tank (11) by the gas supplied from the pump (2). Thus, the pressure sensor (3) can be prevented from being electrically influenced, such as generating noise or being damaged, from the liquid.

In the seventh aspect of the present invention, the control section (16) is configured to make the pump (2) to perform an intermittent operation in a predetermined cycle. Thus, the pump (2) can be operated efficiently, which leads to a reduction in operational cost of the pump (2).

In the eighth aspect of the present invention, the control section (16) is configured to be able to change at least one of the operation time or the halt time of the pump (2). Thus, the amount of liquid to be sprayed from the end of the nozzle (12) can be adjusted.

### BRIEF DESCRIPTION OF THE DRAWINGS

FIG. 1 is an oblique view of an electrostatic spraying device according to an embodiment of the present invention.

FIG. 2 is a view for showing a schematic structure of the electrostatic spraying device according to the embodiment of the present invention.

FIG. 3 is a cross-sectional view of a schematic structure of a connecting portion between a tank and a gas supply pipe.

FIG. 4 is a graph showing a change in pressure in the tank when activation and halt of a pump are repeated according to the pressure in the tank.

FIG. 5 corresponds to FIG. 4 and shows a graph of when the upper limit and the lower limit of the pressure in the tank are increased.

FIG. 6 corresponds to FIG. 2 and shows a schematic structure of an electrostatic spraying device according to an variation of the embodiment.

FIG. 7 is a graph showing a change in pressure in the tank when activation and halt of a pump are performed in a predetermined cycle.

FIG. 8 corresponds to FIG. 7 and shows a graph of when halt time of the pump is reduced.

FIG. 9 corresponds to FIG. 3 and shows an electrostatic spraying device according to another embodiment.

### DESCRIPTION OF EMBODIMENTS

Embodiments of the present invention will be described in detail below based on the drawings. The foregoing embodiments are merely preferred examples in nature, and are not intended to limit the scope, applications, and use of the invention.

### General Structure

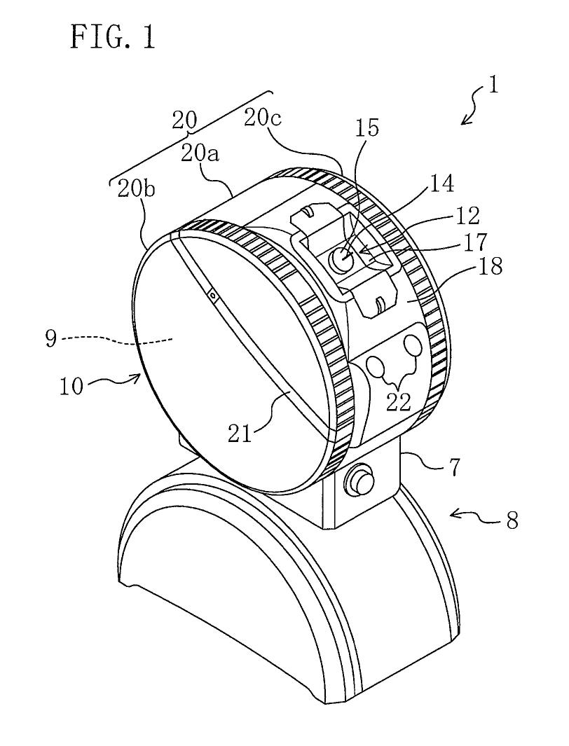

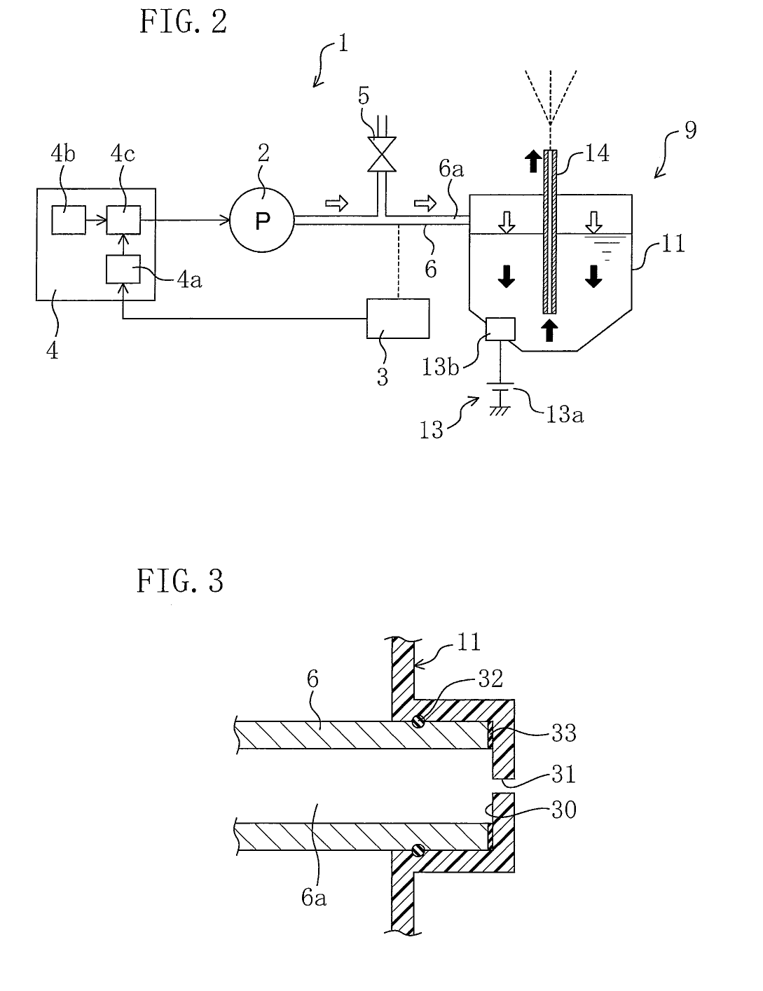

FIG. 1 shows an external view of an electrostatic spraying device (1). FIG. 2 shows a schematic structure of the electrostatic spraying device (1). The electrostatic spraying device (1) is used for spraying a cosmetic liquid containing such as a hyaluronic acid to a face for beauty care, and includes a generally columnar body (10) and a base (8) which is capable of being put on a table, etc., and having a support (7) which supports the body (10) on a side surface of the body (10).

The body (10) has a generally columnar shape, and includes a hollow housing (20). A spray mechanism (9) for spraying a liquid to the outside is accommodated in the housing (20).

The housing (20) includes a generally cylindrical housing body (20a), and generally disc-like first cover (20b) and second cover (20c) covering the respective openings of the ends of the housing body (20a). Further, the housing (20) is positioned such that the central axis of the housing body (20a) extends in a horizontal direction. The housing body (20a) is supported by the support (7) of the base (8) on a side surface of the housing body (20a). That is, the support (7) is attached to a lower portion of the housing (20) as shown in FIG. 1.

A shroud (18) for attaching a nozzle (12), described later, is provided at an upper portion of the housing (20) as shown in FIG. 1. The shroud (18) is configured such that part of the housing body (20a) in a circumferential direction protrudes radially outward. A nozzle recess (17) is formed in the middle of the shroud (18) in a width direction (i.e., in the middle of the shroud (18) in an axial direction of the housing body (20a)). The nozzle recess (17) is formed inwardly of the housing (20), and surrounds the periphery of the nozzle (12).

LEDs (22, 22) from which light is emitted to the liquid to be sprayed from the nozzle (12) are attached to the housing body (20a) at a lower position relative to the shroud (18), with the housing (20) positioned as shown in FIG. 1. The LEDs (22, 22) allow the user of the electrostatic spraying device (1) to see the state of the liquid sprayed.

Each of the first cover (20b) and the second cover (20c) of the housing (20) is made of a generally disc-like member for covering the respective openings of the housing body (20a). The first cover (20b) and the second cover (20c) are attached to the housing body (20a) such that the first cover (20b) covers one side of the housing body (20a), and the second cover (20c) covers the other side of the housing body (20a). Further, band-like counter electrodes (21, 21) are provided on the respective surfaces of the covers (20b, 20c). The counter electrodes (21, 21) enable the electrostatic spraying device (1) to perform so-called cone-jet mode EHD spraying, described later.

The base (8) is made of a generally bowl-like member obtained by cutting a cylindrical member into approximate halves. The support (7) is attached to the curved surface of the generally bowl-like member in the middle along the circumferential direction. Further, the inner wall of the base (8) is configured to be along the round side surface of the housing body (20a). The base (8) is used as a base, with the body (10) supported on the support (7), when the electrostatic spraying device (1) is in use. The base (8) is placed to cover the shroud (18) of the housing body (20a) when the electrostatic spraying device (1) is not in use. Thus, the nozzle (12) is not exposed when the electrostatic spraying device (1) is not in use, by covering the shroud (18) with the base (8).

The spray mechanism (9) is configured to apply pressure to a liquid stored in the tank (11) by supplying gas (air) into the tank (11), and thereby spray the liquid from the end of the nozzle (12) attached to the tank (11) to the outside.

Specifically, the spray mechanism (9) includes, as shown in FIG. 2, a tank (11) in which a liquid is stored, a nozzle (12) for spraying the liquid in the tank (11) to the outside, a voltage applying section (13) for charging the liquid in the tank (11), a gas supply pipe (6) which forms a gas supply path (6a) for supplying gas into the tank (11), and a pump (2) for supplying the gas into the tank (11) through the gas supply pipe (6).

The tank (11) is made of an insulating resin material, and capable of containing a liquid inside the tank (11). The nozzle (12) passes through an upper portion of the tank (11), and connects the interior of the tank (11) with the outside. The gas supply pipe (6) is connected to an upper side wall of the tank (11).

As shown in FIG. 3, an attachment hole (30) for attachment of the gas supply pipe (6) is formed in the side wall of the tank (11). The attachment hole (30) is foamed by recessing part of the side wall of the tank (11) toward the inside of the tank (11), and the gas supply pipe (6) is connected to the tank (11) by being fitted in the attachment hole (30). The attachment hole (30) is formed by recessing part of the side wall of the tank (11) to protrude toward the inside of the tank (11) like a generally cylindrical shape with a bottom. A through hole (31) is formed in a central portion of the bottom of the attachment hole (30). Annular O-rings (32, 33) are provided in the attachment hole (30) on the side surface and the bottom. The O-rings (32, 33) seal between the gas supply pipe (6) and the inner surface of the attachment hole (30), with the end of the gas supply pipe (6) press-fitted in the attachment hole (30). Thus, the interior of the gas supply pipe (6) communicates with the through hole (31) formed in the tank (11).

The through hole (31) has a diameter which can prevent the liquid from flowing in the gas supply pipe (6) due to the surface tension of the liquid even if the liquid in the tank (11) enters in the through hole (31). For example, the through hole (31) may have a diameter of 1 mm, and a length of 2 mm.

The tank (11) is filled with a liquid whose level is under the through hole (31). Thus, it is possible to prevent the liquid in the tank (11) from entering in the gas supply path (6a) via the through hole (31) more reliably.

As shown in FIG. 1, the nozzle (12) includes a small-diameter nozzle body (14) and a nozzle holder (15) for fixing the nozzle body (14) to the housing (20). The length of the nozzle body (14) is such that when one end is under the level of the liquid in the tank (11), the other end is outside the tank (11). The nozzle body (14) connects the interior of the tank (11) with the outside.

The voltage applying section (13) includes a power supply section (13a) serving as a direct-current power supply, and an electrode (13b) attached to the tank (11). A direct-current voltage is applied to the liquid in the tank (11) by the power supply section (13a) via the electrode (13b) attached to a lower portion of the tank (11). The power supply section (13a) may have any structure as long as the structure can supply a direct-current voltage, such as a power supply configured to convert an alternating current voltage supplied from a household power supply to a direct-current voltage.

The gas supply pipe (6) is a pipe member made of a metal material. One end of the gas supply pipe (6) is connected to a discharge opening of the pump (2), and the other end of the gas supply pipe (6) is connected to the attachment hole (30) of the tank (11) as described above. That is, the gas supply pipe (6) forms the gas supply path (6a) through which air pumped by the pump (2) flows into the tank (11).

Further, a relief valve (5) for releasing gas to the outside is provided in a middle of the gas supply pipe (6). The relief valve (5) is configured to release air in the gas supply pipe (6) to the outside when the pressure in the gas supply pipe (6) becomes a predetermined pressure value or higher. With this structure, it is possible to prevent the gas supply pipe (6) and the tank (11) from being damaged by excessive pressure on the gas supply pipe (6) and the tank (11).

The pump (2) forms a gas supply system, and is configured to suction air from an intake opening and discharge the air from a discharge opening. The gas supply pipe (6) is connected to the discharge opening of the pump (2) so that the air is pumped into the gas supply pipe (6). The pump (2) pumps gas to the tank (11) through the gas supply pipe (6) to apply pressure on the liquid in the tank (11). Here, the operation in which the pump (2) supplies air into the tank (11) through the gas supply pipe (6) is a supply operation of the present embodiment.

Further, the electrostatic spraying device (1) includes a pressure sensor (3) for measuring a pressure in the tank (11), and a control section (4) for controlling the driving of the pump (2) according to a value of the pressure in the tank (11) measured by the pressure sensor (3).

The pressure sensor (3) is provided to the gas supply pipe (6), and is configured to output a pressure signal according to a pressure in the gas supply pipe (6) to the control section (4). That is, the pressure sensor (3) detects a pressure in the tank (11) which communicates with the gas supply pipe (6). The control section (4) controls the driving of the pump (2) based on the detection result of the pressure sensor (3).

The control section (4) includes an input section (4a) which receives the pressure signal output from the pressure sensor (3) as a pressure value, a set value storage section (4b) which stores an upper limit and a lower limit of the pressure in the tank (11), and an instruction section (4c) which compares the pressure value received in the input section (4a) with the upper limit and the lower limit stored in the set value storage section (4b), and outputs an instruction signal to the pump based on the comparison result. As described in detail later, the instruction section (4c) is configured to output a stop signal for stopping the pump when the pressure value reaches the upper limit during the operation of the pump (2), and output an activation signal for activating the pump (2) which has been brought to a halt, when the pressure value data reaches the lower limit. That is, the control section (4) is configured to maintain the pressure in the tank (11) in a range between the upper limit and the lower limit stored in the set value storage section (4b). As described in detail later, the electrostatic spraying device (1) sprays the liquid in an amount which is maintained in a predetermined range by the control section (4), from the nozzle body (14) in a stable manner The amount of liquid to be sprayed is adjusted by changing the upper limit or the lower limit stored in the set value storage section (4b).

With this structure, the liquid in the tank (11) is pressurized by the air discharged from the pump (2), and is moved upward through the nozzle body (14) to reach to the end of the nozzle body (14). Here, the liquid in the tank (11) is charged to have a single polarity charge by the application of a direct-current voltage from the voltage applying section (13). The single polarity charges repel one another by electrostatic force at the end of the nozzle body (14). Thus, the liquid is atomized as droplets.

By pressuring the liquid in the tank (11) using the air pumped by the pump (2), and transferring the liquid to the end of the nozzle body (14) as described above, it is possible to spray the liquid from the end of the nozzle body (14) in a more stable manner than in a conventional case using a constant-load spring, of which the pressing force may significantly differ among different constant-load springs.

Further, gas is always present between the pump (2) and the liquid in the tank (11) since the liquid in the tank (11) is pressurized by the gas supplied from the pump (2) via the gas supply path (6a) as described above. Thus, it is possible to prevent the control section (4) which controls the driving of the pump (2) from being in direct contact with the charged liquid via the pump (2).

Moreover, since the pressure sensor (5) for detecting the pressure of the pump (2) is provided to the gas supply pipe (6) which connects the pump (2) and the tank (11), the gas is always present between the pressure sensor (5) and the charged liquid in the tank (11), as well. Thus, it is possible to prevent the pressure sensor (5) from being in direct contact with the charged liquid, and being electrically influenced, such as generating noise or being damaged.

The tank (11) is made of an insulating resin material. Thus, no current flows from the electrode (13b) provided to the tank (11) to the control section (4) or the pressure sensor (5) which control the pump (2) via the gas supply pipe (6) connected to the tank (11).

### Operational Behavior

Now, the behavior of the electrostatic spraying device (1) according to the present embodiment will be described. The electrostatic spraying device (1) performs so-called cone-jet mode electro hydrodynamic spraying (EHD spraying).

When the electrostatic spraying device (1) is activated, the pump (2) is driven, and air is pumped to the tank (11) via the gas supply pipe (6). The pumped air pressurizes the liquid in the tank (11) (see the white arrows in FIG. 2). The liquid pressurized by the air moves upward in the nozzle body (14), which communicates the interior of the tank (11) with the outside, from the lower end of the nozzle body (14) (see the thick black arrows in FIG. 2) to the end of the nozzle body (14).

Since the liquid which reaches to the end of the nozzle body (14) has been charged in the tank (11) by the voltage applying section (13) to have a single polarity charge, the liquid is elongated into a conical shape due to an electric potential difference between the liquid and counter electrode (21) formed in each of the first cover and the second cover (20b, 20c) of the housing (20). Part of the liquid is pulled apart from the tip of the conical air-liquid interface, and atomized.

The driving of the pump (2) is controlled by the control section (4) based on the pressure in the tank (11) which is detected by the pressure sensor (3).

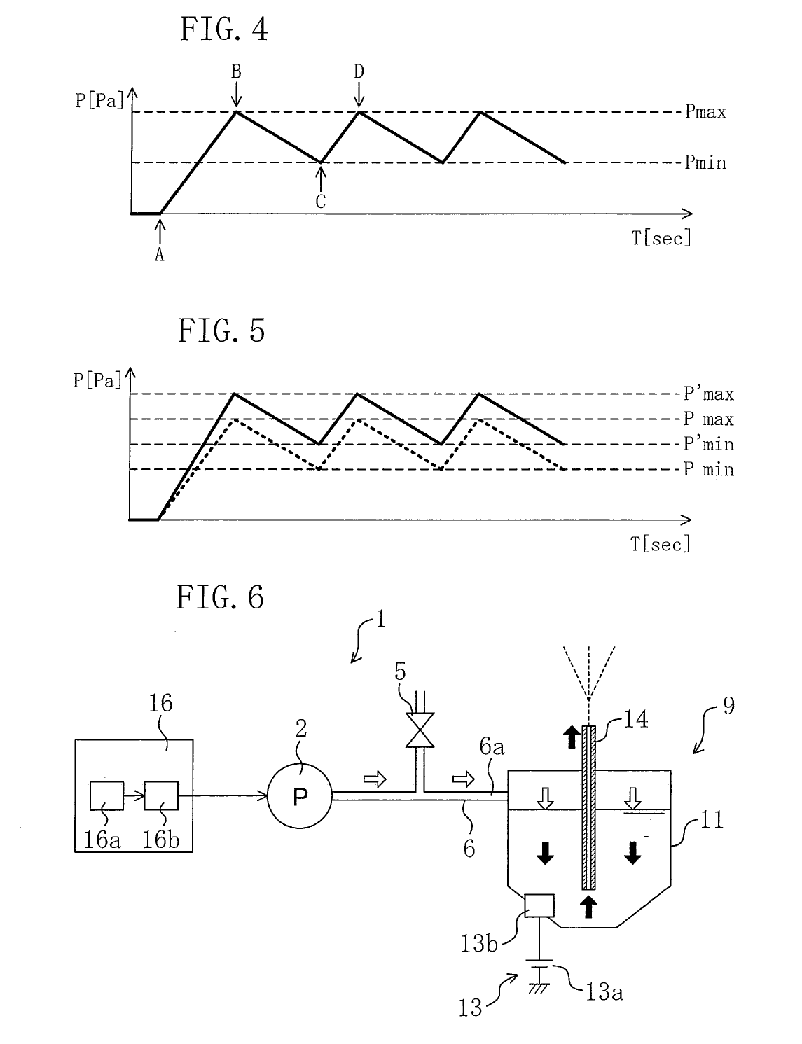

The control of the driving of the pump (2) will be described with reference to FIG. 4. When the pump (2) is activated (arrow A), air is pumped to the tank (11). Thus, the pressure in the tank (11) gradually increases. When the pressure in the tank (11) exceeds a predetermined pressure, the liquid is supplied to the end of the nozzle body (14) and is sprayed from the end of the nozzle body (14).

When the pressure in the tank (11) reaches the upper limit (Pmax) stored in the set value storage section (4b) of the control section (4), the instruction section (4c) of the control section (4) outputs a stop signal to the pump (2) to stop the pumping of air to the tank (11) (arrow B).

The air in the tank (11) continues to apply pressure to the liquid, and therefore, the liquid is supplied to the end of the nozzle body (14) and is sprayed from the end of the nozzle body (14) even during a halt of the pump (2) as described above. The volume of the air in the tank (11) increases with a decrease in volume of the liquid in the tank (11). This means that the pressure of the air in the tank (11) decreases, and the pressure on the liquid decreases, as well.

When the pressure of the air in the tank (11) reaches the predetermined lower limit (Pmin), the instruction section (4c) outputs an activation signal to the pump (2) to activate the pump (2) (arrow C). Therefore, the pressure in the tank (11) increases again by the gas pumped by the pump (2). When the pressure in the tank (11) reaches the predetermined upper limit Pmax, the instruction section (4c) outputs a stop signal to the pump (2) (arrow D).

As described above, the pressure in the tank (11) can be maintained in a range between the predetermined upper limit (Pmax) and the lower limit (Pmin) by controlling the driving of the pump (2) by the control section (4). Here, the largest amount of liquid is sprayed from the end of the nozzle body (14) when the pressure in the tank (11) is the upper limit, and the smallest amount of liquid is sprayed from the end of the nozzle body (14) when the pressure in the tank (11) is the lower limit Thus, by controlling the driving of the pump (2) as described above, the amount of liquid sprayed from the end of the nozzle body (14) can be maintained in a range between the amount to be sprayed when the above-described pressure is the upper limit (Pmax), and the amount to be sprayed when the above-described pressure is the lower limit (Pmin). Moreover, if the lower limit is set to a pressure value which allows the liquid to be supplied to the end of the nozzle body (14) or higher, the liquid can be continuously sprayed from the nozzle body (14). Therefore, the pump (2) can be operated more efficiently than in the case where the pump (2) is always on.

The amount of liquid to be sprayed can be adjusted by changing at least one of the upper limit or the lower limit stored in the set value storage section (4b).

Change in pressure in the tank (11) of when the upper limit and the lower limit are changed will be described based on FIG. 5. For example, if a new upper limit (P′max) and a new lower limit (P′min) which are greater than the upper limit (Pmax) and the lower limit (Pmin) stored in the set value storage section (4b) are input, the average value of the pressure on the liquid in the tank (11) is increased. As a result, the average value of the amount of liquid sprayed from the end of the nozzle body (14) is increased. Further, although not specifically shown in the drawing, the average value of the pressure in the tank (11) is increased, as in the case of FIG. 5, also in the case where only one of the upper limit or the lower limit is increased. Thus, the average value of the amount of liquid sprayed from the end of the nozzle body (14) is increased.

In contrast, if the upper limit and the lower limit stored in the set value storage section (4b) are lowered, the average value of the pressure on the liquid in the tank (11) is decreased. As a result, the average value of the amount of liquid sprayed is decreased. Further, the average value of the pressure in the tank (11) is decreased also in the case where only one of the upper limit or the lower limit is lowered. Thus, the average value of the amount of liquid sprayed from the end of the nozzle body (14) is decreased.

### Effects of Embodiment

As described above, according to the present embodiment, air is sent to the tank (11) in which a liquid is stored, by the pump (2) to apply pressure to the liquid in the tank (11) and supply the liquid to the end of the nozzle body (14). With this structure, the liquid in the tank (11) can be sprayed from the end of the nozzle body (14) in a stable manner. As a result, it is possible to eliminate, unlike the conventional case, variations in the amount of liquid sprayed which may be caused due to individual differences of the constant-load springs.

Since air is supplied from the pump (2) to apply pressure to the liquid in the tank (11) as described above, the air, which is insulative, is always present between the pump (2) and the liquid in the tank (11) With this structure, the pump (2) can be electrically insulated from the charged liquid in the tank (11), and the control section (4) for controlling the driving of the pump (2) can be electrically insulated from the above liquid. That is, the control section (4) can be electrically insulated from the charged liquid in the tank (11) in an easy and reliable manner. Since the tank (11) is made of an insulating resin material, no current flows to the control section (4) via the gas supply pipe (6) connected to the tank (11).

Further, the control section (4) controls the driving of the pump (2) to maintain the pressure in the tank (11) in a range between a predetermined upper limit and a predetermined lower limit Thus, the amount of liquid to be sprayed from the end of the nozzle body (14) can be adjusted without keeping the pump (2) always on. That is, according to the structure of the embodiment, the amount of liquid to be sprayed from the end of the nozzle body (14) can be maintained in a predetermined range by repeating the operations and halts of the pump (2) according to the pressure in the tank (11). Thus, the pump (2) can be driven at lower cost than in the case where the pump (2) needs to be always on to spray a liquid. Further, the control section (4) is configured to be able to change the upper limit and/or the lower limit of the pressure in the tank (11). Thus, the average value of the pressure in the tank (11) can be adjusted by changing at least one of the upper limit or the lower limit. Accordingly, the amount of liquid to be sprayed from the nozzle body (14) can be adjusted.

Further, the pressure sensor (3) for measuring the pressure in the tank (11) is provided in the gas supply pipe (6) communicating with the tank (11), and is surrounded by the air which is insulative. Therefore, the pressure sensor (3) can be electrically insulated from the charged liquid in an easy and reliable manner.

### Variation of Embodiment

The present variation is different from the above embodiment in that the control section controls the driving of the pump (2) such that the operations and halts of the pump (2) are repeated in a predetermined cycle. In the following description, like reference characters are used to designate identical elements as those in the above embodiment, and an explanation is made for only elements different from those in the above embodiment.

As shown in FIG. 6, a control section (16) includes a set value storage section (16a) which stores an operation time and a halt time of the pump (2), and an instruction section (16b) which outputs a signal to the pump (2) based on the operation time and the halt time. The instruction section (16b) outputs, after the activation of the pump (2), a stop signal to the pump (2) when the operation time has passed, and outputs, after the halt of the pump (2), an activation signal to the pump (2) when the halt time has passed.

Thus, in this variation, the liquid in the tank (11) is sprayed by repeating the operations and halts of the pump (2) in a predetermined cycle.

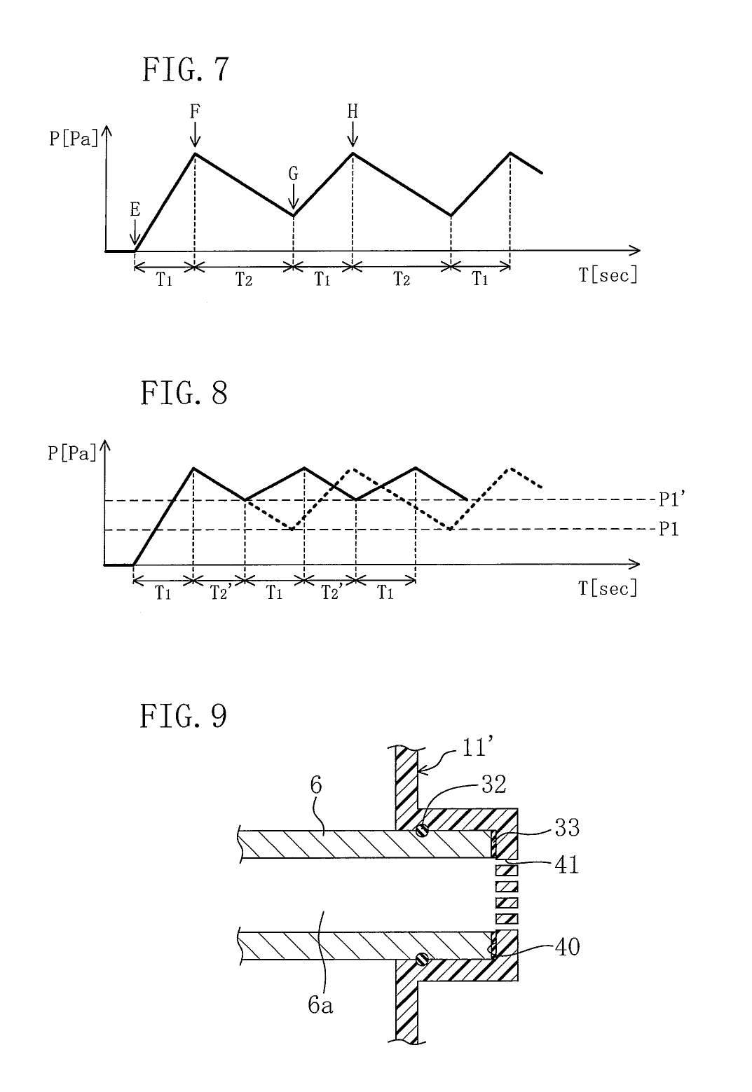

Specifically, similar to the above embodiment, when the pump (2) is activated (arrow E) as shown in FIG. 7, the pressure in the tank (11) increases and the liquid is sprayed from the end of the nozzle body (14). When an operation time (T1) stored in the set value storage section (16a) has passed after the activation of the pump (2), the instruction section (16b) outputs a stop signal to the pump (2) to stop the pump (2) (arrow F).

The air in the tank (11) continues to apply pressure to the liquid, which means that the liquid is sprayed from the end of the nozzle body (14), even during a halt of the pump (2) as described above. Similar to the above embodiment (FIG. 4), the pressure on the liquid in the tank (11) decreases as the liquid is sprayed during the halt of the pump (2). When a halt time (T2) stored in the set value storage section (16a) has passed after the stop of the pump (2), the instruction section (16b) outputs an activation signal to the pump (2) to activate the pump (2) (arrow G). As a result, the pressure in the tank (11) is increased again. When the operation time (T2) has passed after the activation of the pump (2), the instruction section (16b) of the control section (16) outputs a stop signal again to the pump (2) to stop the pump (2) (arrow H).

If the pressure in the tank (11) is such a pressure which allows the liquid to be supplied to the nozzle (12), the liquid can be sprayed from the end of the nozzle (12). Thus, the above intermittent operation of the pump (2) enables the pump (2) to be operated more efficiently than in the case where the pump (2) is always on.

The amount of liquid sprayed can be adjusted by changing at least one of the operation time or the halt time stored in the set value storage section (16a).

A change in pressure in the tank (11) in the case where the halt time is reduced will be described using FIG. 8. If a new halt time (T2′) shorter than the halt time (T2) is input to the set value storage section (16a), the lower limit of a range of pressures in the tank (11) is increased from P1 to P1′. Accordingly, the lower limit of the amount of liquid to be sprayed from the nozzle body (14) is increased. Thus, the average value of the amount of liquid to be sprayed from the nozzle (12) can be increased. On the other hand, although not specifically shown in the drawings, the lower limit of a range of pressures in the tank (11) is lowered if the halt time of the pump (2) is extended. Accordingly, the lower limit of the amount of liquid to be sprayed from the nozzle body (14) is reduced, and the average value of the amount of liquid to be sprayed is reduced.

Further, if the operation time of the pump (2) is extended, the upper limit of a range of pressures in the tank (11) is increased. Accordingly, the upper limit of the amount of liquid to be sprayed is increased, and the average value of the amount of liquid to be sprayed is increased. On the other hand, if the operation time is reduced, the upper limit of a range of pressures in the tank (11) is lowered. Accordingly, the upper limit of the amount of liquid to be sprayed is lowered, and the average value of the amount of liquid is reduced.

### Other Embodiment

The present invention may have the following structures in the above embodiment.

In the above embodiment, the pump (2) is used for supplying a gas to the tank (11). However, the structure is not limited to the pump (2), and any structure which can apply pressure to the liquid in the tank (11) by utilizing a gas may be used. For example, a cylinder filled with a nitrogen gas may be used together with a pressure regulating valve whose driving is controlled by a control section to adjust the pressure of the gas supplied from the cylinder to the tank (11).

In the above embodiment, the pump (2), the pressure sensor (3), the control section (4), the gas supply pipe (6) etc. are accommodated in the housing (20). However, the structure is not limited to this structure, and the pump (2), the pressure sensor (3), the control section (4), the gas supply pipe (6) etc. may be provided outside the housing (20).

In the above embodiment, the electrode (13b) of the voltage applying section (13) is provided to the tank (11). However, the structure is not limited to this structure, and the electrode (13b) may be provided to the nozzle body (14). In this case, the nozzle body (14) may be made of a metal, or the electrode (13b) made of metal may be attached to the nozzle body (14) made of resin, and a voltage is applied to the nozzle body (14) or the electrode (13b) to charge the liquid.

In the above embodiment, the tank (11) is made of an insulating resin material. However, the structure is not limited to this structure. For example, if the tank (11) is made of a conductive material, the gas supply pipe (6) may be made of an insulating material, or an insulating portion may be provided to the tank (11) or the gas supply pipe (6), for insulating the pump (2) from the liquid in the tank (11) or the electrode (13b).

In the above embodiment, one through hole (31) which communicates between the interior of the tank (11) and the gas supply path (6a) is provided at an upper portion of the side wall of the tank (11). However, the structure is not limited to this structure, and a plurality of through holes (41, 41, . . .) may be formed in an attachment hole (40) of a tank (11′) as shown in FIG. 9. In this case, the diameter of each of the plurality of through holes (41, 41, . . .) may be 0.5 mm, for example.

### INDUSTRIAL APPLICABILITY

As described above, the present invention is useful as an electrostatic spraying device which sprays a liquid from an end of a nozzle.

### DESCRIPTION OF REFERENCE CHARACTERS

1 electrostatic spraying device

2 pump (gas supply system)

3 pressure sensor

4, 16 control section

6a gas supply path

11, 11′ tank

12 nozzle

13 voltage applying section

1. An electrostatic spraying device, comprising:
a tank (11) in which a liquid is stored;
a nozzle (12) provided in the tank (11);
a voltage applying section (13) for charging the liquid in the tank (11) so that the liquid is sprayed from an end portion of the nozzle (12) to the outside;
a gas supply path (6a) which communicates with the tank (11);
a gas supply system (2) connected to the gas supply path (6a), for supplying a gas to the tank (11) via the gas supply path (6a); and
a control section (4, 16) for controlling a supply operation of the gas supply system (2) to adjust a pressure in the tank (11).

2. The electrostatic spraying device of claim 1, wherein
the gas supply system is a pump (2) which pumps the gas to the tank (11), and
the control section (4, 16) is configured to control driving of the pump (2).

3. The electrostatic spraying device of claim 1 or 2, wherein
the tank (11) is made of an insulating resin material.

4. The electrostatic spraying device of claim 2, wherein
the control section (4) stops the pump (2) when the pressure in the tank (11) reaches an upper limit during an operation of the pump (2), and activates the pump (2) when the pressure in the tank (11) reaches a lower limit during a halt of the pump (2).

5. The electrostatic spraying device of claim 4, wherein
the control section (4) is configured to be able to change at least one of the upper limit or the lower limit

6. The electrostatic spraying device of claim 4 or 5, wherein
a pressure sensor (3) for measuring the pressure in the tank (11) is provided to the gas supply path (6a).

7. The electrostatic spraying device of claim 2, wherein
the control section (16) controls the driving of the pump (2) such that the pump (2) performs an intermittent operation in which an operation and a halt of the pump (2) are repeated in a predetermined cycle.

8. The electrostatic spraying device of claim 7, wherein
the control section (16) is configured to be able to change at least one of an operation time or a halt time of the pump (2).
